(19) United States
(12) Patent Application Publication
(10) Pub. No.: US 2009/0194613 A1
(43) Pub. Date: Aug. 6, 2009

(54) Shower head apparatus with adjustable water flow rate control

(76) Inventor: Hoi Kwan Henry Mang, Hong Kong (HK)

Correspondence Address: DAVID AND RAYMOND PATENT FIRM, 108 N. YNEZ AVE., SUITE 128, MONTEREY PARK, CA, 91754, US

(21) Appl. No.: 12/381,540

(22) Filed: Mar. 13, 2009

Related U.S. Application Data
(62) Division of application No. 12/313,197, filed on Nov. 17, 2008.

(30) Foreign Application Priority Data
Feb. 6, 2008 (CN) CN200820116387.7

(51) Int. Cl. B05B 1/14

(52) U.S. Cl. 239/562

(57) ABSTRACT

A shower head apparatus includes a shower head and an adjustable water flow rate control for adjustably control the rate of the water flow through the passage of the shower head. The adjustable water flow rate control includes a control knob and a control valve which is rotatably supported within the shower head and is driven to be rotated via the control knob, wherein the control valve has a water through channel aligning with the passage, in such a manner that when the control knob is selectively rotated at its rotational angle to drive the control valve to rotate, the water through channel of the control valve is adjustably offset with the passage for controlling the water flow rate through the shower head. Therefore, the present invention is adapted to provide better shower experience and to provide a water saver feature for the shower head.

### CROSS REFERENCE TO RELATED APPLICATION

This is a divisional application of a non-provisional application having an application Ser. No. 12/313,197 and a filing date of Nov. 17, 2008.

### BACKGROUND OF THE PRESENT INVENTION

1. Field of Invention

The present invention relates to a bathroom equipment, and more particularly to a shower head apparatus with an adjustable water flow rate control for selectively adjusting the rate of water flow through the shower head.

2. Description of Related Arts

Shower head is one of the indispensable daily needs of bathroom equipments. It usually comprises a head portion or a handle portion coupling with the head portion. For the convenience of using the shower head and for water saving, we have developed the present invention which incorporates an adjustable flow rate device, such that a user can adjust the flow rate of the shower head according to different water pressures at different places. Accordingly, the user can adjust the flow rate of the shower head to provide better shower experience and cut down the water waste so as to conserve the environment.

### SUMMARY OF THE PRESENT INVENTION

A main object of the present invention is to provide a shower head apparatus with an adjustable water flow rate control to improve the conventional shower head in the market that cannot adjustably control the water flow rate through the shower head.

Accordingly, in order to accomplish the above object, the shower head apparatus comprises a shower head having a head portion, a handle portion, and a passage for water flow passing from the handle portion to the head portion. The shower head apparatus further comprises an adjustable water flow rate control provided at the handle portion of the shower head for adjustably control the rate of the water flow through the passage of the shower head. Accordingly, the adjustable water flow rate control comprises a control knob rotatably coupled at the shower head and a control valve which is rotatably supported within the shower head and is driven to be rotated via the control knob, wherein the control valve has at least a water through channel aligning with the passage, in such a manner that when the control knob is selectively rotated at its rotational angle to drive the control valve to rotate, the water through channel of the control valve is adjustably offset with the passage for controlling the water flow rate through the shower head.

Accordingly, when the control knob is rotated at a first rotational angle, the water flow rate through the shower head is maximized.

When the control knob is rotated at a second rotational angle, the water flow rate through the shower head is reduced.

When the control knob is rotated at a third rotational angle, the water flow rate through the shower head is minimized.

Accordingly, the control valve has a hollow structure having a drum shape or a barrel shape.

Preferably, the control valve has three water through channels in different sizes.

The control knob is coupled with the control valve via a locking screw to retain the control knob and the control valve at two sides of the shower head respectively.

At least a first sealing O-ring is coupled with the outer surface of the control valve for preventing water leakage.

At least a second sealing O-ring is coupled with the outer surface of the control knob for preventing water leakage.

Accordingly, the adjustable water flow rate control of the present invention can be installed at either the head portion or the handle portion of the shower head for selectively adjusting the rate of water flow through the passage of the shower head, so as to provide a water saver feature for the shower head as one of the improved bathroom equipments.

These and other objectives, features, and advantages of the present invention will become apparent from the following detailed description, the accompanying drawings, and the appended claims.

### BRIEF DESCRIPTION OF THE DRAWINGS

FIG. 1 is a side view of a shower head apparatus with an adjustable water flow rate control according to a first preferred embodiment of the present invention, illustrating the adjustable water flow rate control provided at the handle portion of the shower head.

FIG. 2 is a sectional view of the shower head apparatus according to the above first preferred embodiment of the present invention.

FIG. 3 is sectional view of the adjustable water flow rate control according to the above first preferred embodiment of the present invention.

FIG. 4 is a schematic view of the adjustable water flow rate control according to the above first preferred embodiment of the present invention, illustrating the control knob being rotated at a first rotational angle.

FIG. 5 is a schematic view of the adjustable water flow rate control according to the above first preferred embodiment of the present invention, illustrating the control knob being rotated at a second rotational angle.

FIG. 6 is a schematic view of the adjustable water flow rate control according to the above first preferred embodiment of the present invention, illustrating the control knob being rotated at a third rotational angle.

FIG. 7 is an exploded view of the adjustable water flow rate control according to the above first preferred embodiment of the present invention.

### DETAILED DESCRIPTION OF THE PREFERRED EMBODIMENT

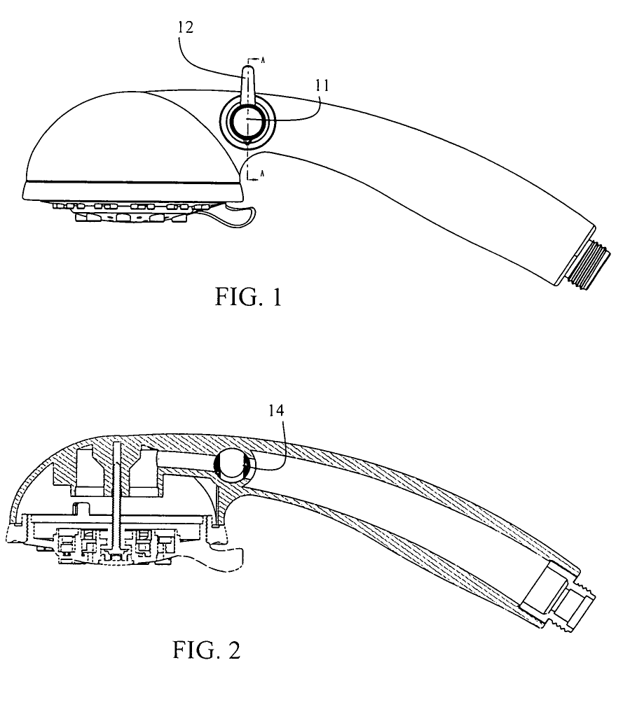

Referring to FIGS. 1, 2 and 3 of the drawings, a shower head apparatus according to a preferred embodiment of the present invention is illustrated, wherein the shower head 18 apparatus comprises a shower head having a head portion, a handle portion, and a passage extended therebetween for water flow passing from the handle portion to the head portion. The shower head apparatus further comprises an adjustable water flow rate control provided at the handle portion of the shower head for adjustably control the rate of the water flow through the passage of the shower head. Accordingly, the adjustable water flow rate control comprises a control knob 12 rotatably coupled at the shower head and a cylindrical control valve 14 which is rotatably supported within the shower head and is driven to be rotated via the control knob 12, wherein the control valve 14 has at least a water through channel aligning with the passage, in such a manner that when the control knob 12 is selectively rotated at its rotational angle to drive the control valve 14 to rotate, the water through channel of the control valve 14 is adjustably offset with the passage for controlling the water flow rate through the shower head.

As shown in FIG. 4, when the control knob 12 is rotated at 20° as the rotational angle with respect to its horizontal orientation, the water flow rate through the shower head is maximized. In other words, the water through channel is fully aligned with the passage. It is worth to mention that the water flow rate can be either gradually increased or gradually decreased when the rotational angle is increased. In addition, the rotational angle, i.e. 20°, mentioned above is an example in which the rotational angle can be variably set at any desired angle.

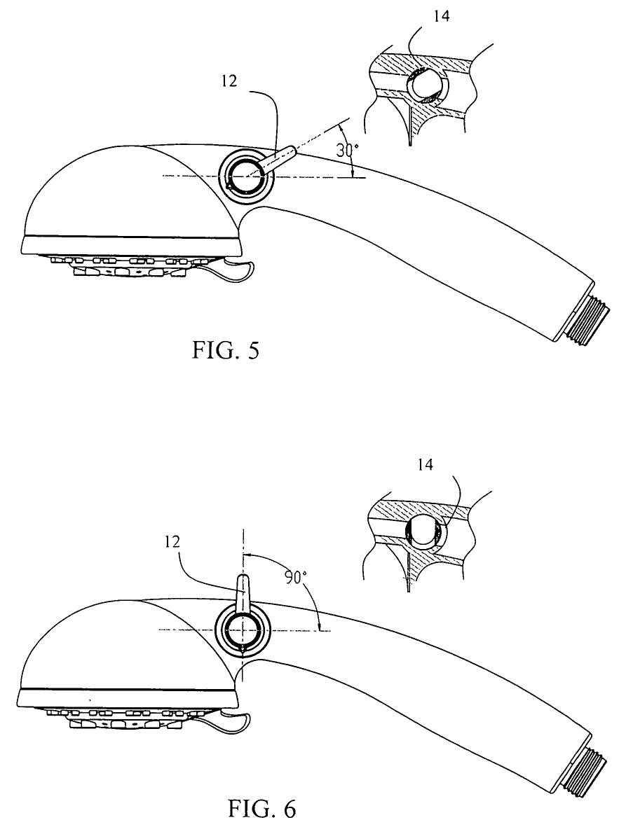

As shown in FIG. 5, when the control knob 12 is rotated at 30° as the rotational angle with respect to its horizontal orientation, the water flow rate through the shower head is reduced. In other words, the water through channel is partially aligned (or partially offset) with the passage. It is worth to mention that the water flow rate can be either gradually increased or gradually decreased when the rotational angle is increased. In addition, the rotational angle, i.e. 30°, mentioned above is an example in which the rotational angle can be variably set at any desired angle.

As shown in FIG. 6, when the control knob 12 is rotated at 90° as the rotational angle with respect to its horizontal orientation, the water flow rate through the shower head is minimized such that the water through channel is blocked to attain a minimum flow rate. As a result, no water or only a little amount of water can pass through the passage. It is worth to mention that the water flow rate can be either gradually increased or gradually decreased when the rotational angle is adjusted. In addition, the rotational angle, i.e. 90°, mentioned above is an example in which the rotational angle can be variably set at any desired angle.

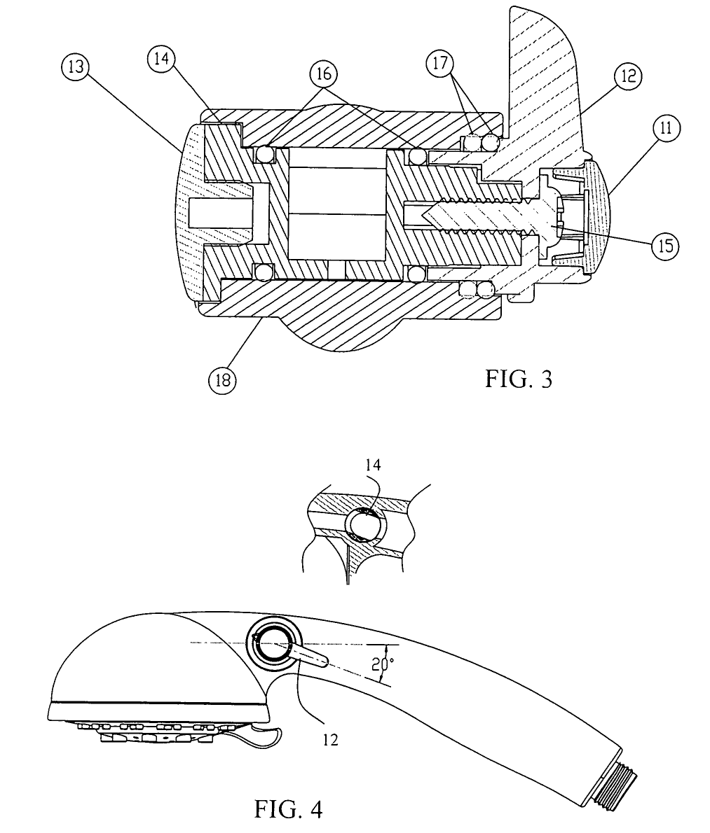

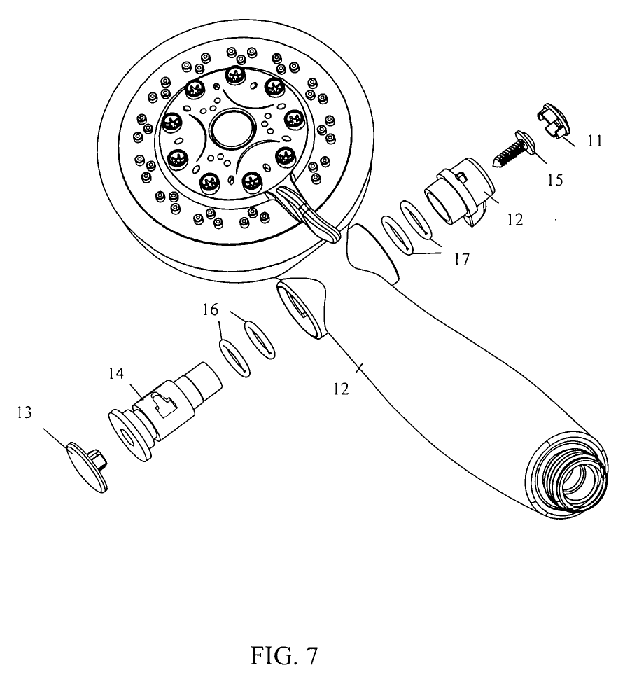

As shown in FIGS. 3 and 7, the control knob 12 is coupled at one side of the shower head while the control valve 14 is coupled at another side of the shower head, wherein the control knob 12 is coaxially coupled with the control valve 14 through the passage via a locking screw 15. At least a first sealing O-ring 16 is coaxially coupled with the outer surface of the control valve 14 for preventing water leakage between the control valve 14 and the shower head. At least a second sealing O-ring 17 is coaxially coupled with the outer surface of the control knob 12 for preventing water leakage between the control knob 12 and the shower head. Accordingly, the control valve 14 has a hollow structure having a drum shape or a barrel shape.

A screw cap 11 is coupled at the control knob 12 to cover the head of the locking screw 15. A valve cap 13 is coupled at the control valve 14 at a position opposite to the control knob 12.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A shower head apparatus, comprising:
a shower head having a head portion, a handle portion, and a passage extended therebetween for water flow passing from said handle portion to said head portion; and
an adjustable water flow rate control provided at said shower head for adjustably control a rate of said water flow through said passage of said shower head, wherein said adjustable water flow rate control comprises a control valve rotatably supported within said shower head, wherein said control valve has a water through channel aligning with said passage and arranged in such a manner that when said control valve is driven to rotate, said water through channel of said control valve is adjustably offset with said passage for controlling said water flow rate through said shower head.

2. The shower head apparatus, as recited in claim 1, wherein said adjustable water flow rate control is provided at said handle portion of said shower head.

3. The shower head apparatus, as recited in claim 1, wherein said adjustable water flow rate control further comprises a control knob rotatably coupled at said shower head to drive said control valve to rotate at said shower head so as to adjust said water through channel with said passage.

4. The shower head apparatus, as recited in claim 2, wherein said adjustable water flow rate control further comprises a control knob rotatably coupled at said shower head to drive said control valve to rotate at said shower head so as to adjust said water through channel with said passage.

5. The shower head apparatus, as recited in claim 3, wherein when said control knob is rotated at a first rotational angle, said water through channel is fully aligned with said passage such that said water flow rate through said shower head is maximized, wherein when said control knob is rotated at a second rotational angle, said water through channel is partially aligned with said passage such that said water flow rate through said shower head is reduced, wherein when said control knob is rotated at a third rotational angle, said water through channel is fully offset with said passage such that said water flow rate through said shower head is minimized.

6. The shower head apparatus, as recited in claim 4, wherein when said control knob is rotated at a first rotational angle, said water through channel is fully aligned with said passage such that said water flow rate through said shower head is maximized, wherein when said control knob is rotated at a second rotational angle, said water through channel is partially aligned with said passage such that said water flow rate through said shower head is reduced, wherein when said control knob is rotated at a third rotational angle, said water through channel is fully offset with said passage such that said water flow rate through said shower head is minimized.

7. The shower head apparatus, as recited in claim 5, wherein said water flow rate is gradually reducing when said control knob is rotated from said first rotational angle to said third rotational angle through said second rotational angle.

8. The shower head apparatus, as recited in claim 6, wherein said water flow rate is gradually reducing when said control knob is rotated from said first rotational angle to said third rotational angle through said second rotational angle.

9. The shower head apparatus, as recited in claim 4, wherein said control knob is coupled at one side of said shower head while said control valve is coupled at another side of said shower head, wherein said control knob is coaxially coupled with said control valve through said passage.

10. The shower head apparatus, as recited in claim 8, wherein said control knob is coupled at one side of said shower head while said control valve is coupled at another side of said shower head, wherein said control knob is coaxially coupled with said control valve through said passage.

11. The shower head apparatus, as recited in claim 9, wherein said adjustable water flow rate control further comprises at least a first sealing O-ring coaxially coupled with an outer surface of said control valve for preventing water leakage between said control valve and said shower head.

12. The shower head apparatus, as recited in claim 10, wherein said adjustable water flow rate control further comprises at least a first sealing O-ring coaxially coupled with an outer surface of said control valve for preventing water leakage between said control valve and said shower head.

13. The shower head apparatus, as recited in claim 11, wherein said adjustable water flow rate control further comprises at least a second sealing O-ring coaxially coupled with an outer surface of said control knob for preventing water leakage between said control knob and said shower head.

14. The shower head apparatus, as recited in claim 12, wherein said adjustable water flow rate control further comprises at least a second sealing O-ring coaxially coupled with an outer surface of said control knob for preventing water leakage between said control knob and said shower head.

15. The shower head apparatus, as recited in claim 4, wherein said control valve has a hollow structure having a drum shape.

16. The shower head apparatus, as recited in claim 14, wherein said control valve has a hollow structure having a drum shape.

17. The shower head apparatus, as recited in claim 4, wherein said control valve has a hollow structure having a barrel shape.

18. The shower head apparatus, as recited in claim 14, wherein said control valve has a hollow structure having a barrel shape.

19. The shower head apparatus, as recited in claim 4, wherein said adjustable water flow rate control further comprises a locking screw coupling with said control knob to lock up said control valve with said control knob, a screw cap coupled at said control knob to cover a head of said locking screw, and a valve cap is coupled at said control valve at a position opposite to said control knob.

20. The shower head apparatus, as recited in claim 14, wherein said adjustable water flow rate control further comprises a locking screw coupling with said control knob to lock up said control valve with said control knob, a screw cap coupled at said control knob to cover a head of said locking screw, and a valve cap is coupled at said control valve at a position opposite to said control knob.
